(19) United States
(12) Patent Application Publication
(10) Pub. No.: US 2023/0330780 A1
(43) Pub. Date: Oct. 19, 2023

(54) METHOD AND APPARATUS FOR AUTOMATED QUALITY CONTROL FOR CUTTING MACHINES OF FLEXIBLE MATERIAL PARTS

(71) Applicant: HEFA Holding GmbH, Heusenstamm (DE)

(72) Inventor: Gunnar Held, Heusenstamm (DE)

(21) Appl. No.: 18/044,481

(22) PCT Filed: Sep. 9, 2021
(86) PCT No.: PCT/EP2021/074795

§ 371 Date: Mar. 8, 2023

(30) Foreign Application Priority Data
Sep. 9, 2020 (DE) 10 2020 123 555.0

(51) Int. Cl. B23K 26/38; B23K 26/08; G05B 19/418; G06T 7/00; D06M 10/00; D06H 3/08; D06H 1/00

(52) U.S. Cl. CPC B23K 26/38; B23K 26/0838; G05B 19/41875; G06T 7/001; D06M 10/005; D06H 3/08; D06H 1/00; G05B 2219/32368; B60R 2021/23533

(57) ABSTRACT

In order to specify an automated method and an apparatus enabling a quick, reliable and reproducible quality assurance and being easily integrated in existing machines, a cutting machine is specified, comprising: a conveyor (10) for conveying flexible material (100); a machining unit (20) for cutting the flexible material (100) into material parts (200); a recognition unit (30) for detecting the flexible material (100) and/or at least one cut material part (200), the recognition unit (30) being arranged in the conveying direction after the machining unit (20), and a control unit (50) configured to generate a quality result and to control the cutting machine based on information of the recognition unit (30) and/or on marking information.

### TECHNICAL FIELD OF THE INVENTION

The invention relates to a method and an apparatus for automated quality control for cutting machines of flexible materials, especially of fabric material parts, e.g., cutout of a material web of flexible material. The invention is especially suited for the quality control of fabric material parts or patterns for airbags, e.g., from One-Piece-Woven fabric (OPW fabric) or other fabric, but not limited to such applications. Preferably, the invention is applied to a laser cutting machine.

In the previously known methods for manufacturing material parts cut from a flexible material, as for example airbags or airbag parts, the flexible material, especially in the form of fabric, technical textiles, carbon fiber, fiberglass, airbag or OPW fabric, respectively, seat covers, or coated or uncoated, single-layered or multi-layered metal or plastic sheets, is supplied on an essentially horizontal conveyor to a cutting machine, especially a laser cutting machine. In certain cases, and depending on the application, already before the cutting process, the flexible material may be readily welded, adhered, weaved, or preprocessed in general.

In conventional cutting machines, after the cutting process, the cut material parts are manually doffed and subsequently laid out again in a separate inspection station and undergo a visual and/or haptical quality control by employees.

The quality requirements for cut parts, especially for airbags, are very high, as these components are subjected to extreme strains in an accident, and the airbags can only increase the safety of the passengers when functioning flawlessly. This applies in general to all flexible materials, from which material parts are cut. The modern cutting technology, especially by means of a laser, allows for complex cutting sequences, the optical inspection of which is costly and prone to error, especially when this inspection is performed manually by humans.

In addition to an increase of the number of the airbags in a vehicle, also the size of the airbags themselves increases, in some instances, the airbags extend through the whole transverse side of a vehicle from the A-pillar to the C-pillar. Therefore, such complex airbag parts have dimensions of, in some instances, multiple meters. Despite a steady increase of the manufacturing quality, a quality control in this kind of components remains inevitable.

The previous manual quality control is a monotone, demanding activity, yet at the same time requires a high degree of focus. With the increasing number of airbags in a vehicle and an ever-growing complexity of the individual airbag parts, laying them out and the subsequent manual quality control become increasingly costly and complex. In addition, at smaller quantities and a larger number of different parts, securely recognizing deviations of the individual parts from the standard becomes especially difficult for the employees. Faster cutting processes and the associated growing throughput additionally increase the burden of the employees and the quality control may become the limiting factor in the capacity of the facility. In addition, the manual quality control is subject to the subjective perception of the employee. This may lead to a different sorting depending on the employee in the quality control and thus to different quality standards. In the case of an absence of employees, they are often difficult to replace, and manufacturing may stall. Thus, it may occur that, due to errors of the employee, defective parts reach the further production process as good parts.

A repositioning of finished cut parts to separate quality control tables or stations has the disadvantage that the position of the cut material part is changed, and potentially existing tabs or protrusions are stored falsely or folded over and thus, all deviations cannot be recognized any longer.

Furthermore, in many applications, a traceability of the production is required. Many customers of such cut material parts demand, for example, for the quality control and/or the further machining information on the cut material parts, including quality data, cutting data or coordinates, machining data, machining parameters. This information is established during the cutting process and/or exists at the time of the cutting process and/or is delivered already by preliminary stages of the production or the manufacturing, respectively, od the material to a cutting machine.

Therefore, an object of the invention is to specify an automated method and an apparatus enabling a quick, reliable, and reproducible quality assurance removing the above disadvantages of the previous quality assurance and being easily integrated in existing machines, in order to be able to meet novel quality standards with an existing machine.

A further object of the invention is to specify an automated method and an apparatus by which information for quality assurance may be securely and efficiently associated to the cutout material parts.

These objects are solved by the subject matters of the independent claims. Advantageous developments of the invention are given in the dependent claims.

The invention is based on the idea of not having to additionally move, at a cutting machine, the cutout material parts and creating a quality result by means of an inline quality control. By the lack of relocation of the cutout material parts, defects potentially caused or concealed, respectively, by repositioning may be avoided. Further, the inline quality control leads to an increase of the throughput and to a high reproducibility.

Another aspect of the invention relates to marking the cutout material parts. Thus, information on the quality result may be securely attached or allocated to the cutout material parts, to thus ensure a quality assurance and/or securely recognize defective parts, and also one or more additional information on the material and/or the previous machining process may be attached or allocated.

In a first aspect, a cutting machine is specified, comprising: a conveyor for conveying flexible material; a machining unit for cutting the flexible material into one or more material parts; a recognition unit for detecting the flexible material and/or at least one cut material part, the recognition unit arranged in the conveying direction after the machining unit, and a control unit, configured to generate, based on information of the recognition unit and/or marking information, a quality result and, if applicable, control the cutting machine.

Thus, a recognition unit is arranged here as an inline quality control unit immediately after the machining unit for cutting. The cutout material parts are moved out of the machining unit by the conveyor and may thus immediately undergo quality control without further repositioning. That is, the flexible material parts may not be changed in their position and the quality control unit, also referred to as recognition unit, may recognize all cuttings, seams, weavings, holes, tabs, or protrusions at the intend position and inspect whether they match the cutting data and/or reference data or lie within the given tolerances, respectively.

Alternatively or additionally, the recognition unit may also be placed before the machining unit, for example to recognize material defects also already before the cutting.

In the generation of the quality result, also marking information stemming from preliminary production stages or material manufacturing may be co-processed additionally.

Alternatively or additionally, the cutting machine may comprise a marking unit for marking the flexible material and/or the at least one cut material part based on the quality result. The marking may, for example, occur by imprinting on the cut material part or by cutting or marking (scribing, partial melting the surface) the cut material part. Preferably, the cutting or marking, respectively, may still be made by the machining unit, e.g., by a laser. There may also existing a downstream printer for imprinting.

The marking unit may be arranged in the conveying direction before and/or after the machining unit. A marking unit before the machining unit may, for example, apply information on the material or material defects to the material at the corresponding position. Thus, it is easier for the recognition unit, in the quality control, to recognize a material defect already existing before the cutting.

Alternatively or additionally, the marking unit may also be arranged in the conveying direction after the recognition unit to thereby also let the quality result feed into the marking. The marking, especially of recognized defects, is very important to prevent a later further processing of defective parts as safely as possible.

In another aspect, a cutting machine is specified, comprising: a conveyor for conveying flexible material; a machining unit for cutting the flexible material into one or more material parts; a marking unit for marking the flexible material and/or the at least one cut material part based on information of the cutting machine and/or of the flexible material, the marking unit arranged in the conveying direction before and/or after the machining unit.

In this aspect, no recognition unit must be provided, and the marking unit serves mostly for the application of information of the material and/or the machining process.

Such a cutting machine may of course also be extended by the above recognition unit. The recognition unit serves for detecting the flexible material and/or at least one cut material part, the recognition unit arranged in the conveying direction after and/or before the machining unit.

The control unit may be configured to, based on information of the recognition unit and/or marking information, to generate a quality result and, if applicable, control the cutting machine.

Preferably, the flexible material may be a flexible fabric, a single-layered or multi-layered plastic sheet or a single-layered or multi-layered metal sheet, a textile, technical textile, e.g., a carbon fiber or fiberglass material (e.g., aramid), and/or an at least partly single-layered, double-layered, and/or multi-layered fabric. The flexible material may be uncoated or coated on one or both sides.

Preferably, the flexible material may be a flexible fabric for airbag production.

Preferably, the flexible material may be conveyed from a reel onto the conveyor. A delivery of the flexible material in large already cut plates or panels is also possible.

In a preferred development, the cutting machine may comprise a doffing apparatus. The doffing apparatus serves for doffing the at least one cut material part off the conveyor. The doffing apparatus may be arranged after the recognition unit or, in case the marking unit exists, after the marking unit.

In a preferred development, the cutting machine may comprise a residual material doffing apparatus or also residual fabric extraction apparatus for doffing a residual material or residual fabric. The residual fabric extraction apparatus may be arranged in the conveying direction before or after the recognition unit and/or in the conveying direction before or after the marking unit.

In an optional arrangement of the residual material doffing apparatus before the recognition unit, the quality control to be performed is easier, as the edges of the cutout material part may be recognized more easily. However, it must be accepted thereby that, by doffing the residual material/residual fabric, if applicable, a change in position of the cutout material part may occur and possibly badly or incompletely cut areas may lead to a stop of the process.

In an arrangement of the residual material doffing apparatus after the recognition unit, the quality control to be performed is more demanding, as now, the cuts need to be recognized. However, it is accomplished thereby that the cutout material part for the quality control remains at its position.

The residual material doffing apparatus may be arranged in the conveying direction at the same position as the doffing apparatus or in the conveying direction after the doffing apparatus. This is advantageous when the required length in the hall for the conveyor is limited.

In a preferred development, the control unit may be configured to control, based on information of the recognition unit and/or marking information, the doffing apparatus and/or the residual material doffing apparatus and/or the marking unit. Thus, it is possible, based on the quality result, to control and, if applicable, stop the subsequent units or, with well recognized material parts, the corresponding doffing by the doffing apparatus, respectively.

In a preferred development, the recognition unit may comprise a camera and/or a transmitter and receiver and/or one or more sensors, and/or an illumination unit. Depending on the material, different equipment may be deployed for quality control. So, for example with single-layered or multi-layered fabric, it is reasonable to process the cutout material part with a camera and depending on the thickness of the fabric with additional illumination. In multi-layered coated foils, an ultrasound apparatus consisting of transmitter and receiver may be deployed.

Preferably, the illumination unit may output light with a wavelength adapted to the material or a material composition.

Preferably, the flexible material may lie between transmitter and receiver and the transmitter may, e.g., output ultrasound, which is then received by the receiver to obtain information on the material composition of the flexible material.

The recording area of the camera or of the sensor may comprise a square, rectangular, and/or linear shape. So, for example, strip-shaped images may be recorded, which are then composed in the control unit to recognize, for example by means of contrast differences, the cuttings, seams, holes etc. Depending on the application and e.g., the conveying speed, also a strip-shaped partial image may already be inspected for defects or tolerances, respectively.

Preferably, the illumination unit may be arranged on a side of the recognition unit opposite the flexible material and/or facing the flexible material.

The illumination unit may also be arranged between the conveyor and the flexible material.

In a preferred development, the quality result may be based on an inspection of the position of the cuttings and the number of the seams and/or the position and number of cutouts/holes and/or on the quality of weaved places and/or welding seams and/or adhesive areas and/or on the position of the weaved places, adhesive areas, and/or welding seams and/or on the position of markings at the flexible material.

In a preferred development, the control unit may be configured, to examine the at least one cutout material part for warpage. To do so, it may be inspected, whether the length and/or the width of the at least one cutout material part corresponds to the target or reference specifications and/or whether tabs, protrusions, or cutouts are arranged at the at least one cutout material part in the respective correct position.

In a preferred development, the control unit may be configured to display, through an optical output unit at the machine, e.g., in the form of a lamp, or at a display, an approved airbag part. That is, with a positive quality result, in the lane of the approved airbag part, a green lamp or LED lights up, or the machine operator obtains this information at a display, wherein the good airbag parts on the display are colored with a color predetermined for approval.

Alternatively or additionally, it is also possible, e.g., through an approved airbag part to display, through a projection of the quality result on the airbag part. That is, a green dot, e.g., may be irradiated onto an approved airbag part.

With a negative quality result for a defective airbag part, the optical output unit may display this airbag part as a scrap part or as a reworkable airbag part, e.g., by red for a scrap part and yellow for a reworkable airbag part.

Also here, the output of the quality result may occur by means of a projection onto the airbag part or also onto the material part in general.

In general, the control unit may output its quality result through an optical output unit and/or at a display or display the quality result for a material part by projection onto the material part.

In a preferred development, the recognition unit may recognize a marking of material defects on the flexible material.

Material defects of the flexible material or their position, already known before the cutting, may also be included in a file being processed by the control unit of the cutting machine to correspondingly control the doffing apparatus and, if applicable, the marking unit and not to doff and/or mark defective the defective material part.

In a preferred development, the flexible material may be a fabric band, especially for airbag production, which has multi-layered areas and single-layered areas, e.g., a one-piece-woven (OPW) fabric.

Preferably, the machining unit may be a laser cutting apparatus for cutting out fabric material parts for airbag production.

In a preferred development, the control unit may be configured to, at a positive quality result, approve the corresponding cut fabric material part for doffing and, at a negative quality result, categorize a defective airbag part as a scrap part or as a reworkable airbag part.

In a preferred development, the control unit may be configured to control the doffing apparatus such that the scrap parts and the reworkable OPW fabric material parts are stored separately from each other.

Preferably, the control unit may be configured, based on the information of the recognition unit, to identify a defect and/or a cause of defect and/or to correct these and/or output hints for defects and/or wear to the cutting machine. Thus, repeated defects may be avoided, and the scrap rate reduced. By outputting the defect as an optical or acoustical warning signal, the machine operator may intervene and, if applicable, make changes for following cutting processes, in order improve the quality for subsequent parts.

In a preferred development, the control unit may be configured to carry out the quality control during a continuous and/or discontinuous and/or stopped operation of the cutting machine. That is, the recognition unit may also record a photo with a stopped conveyor belt and then compose this with the following photos at continuation of the process, to recognize the posture of the cuttings, seams, holes etc.

In another aspect, a method for automated inline quality control of at least one material part, cutout from a flexible material is specified, comprising the following steps: supplying a flexible material on a conveyor, cutting the flexible material by means of a machining unit into one or more material parts; detecting at least a part of the flexible material and/or of the cutout material part by means of a recognition unit; and performing a quality control based on information of the recognition unit and at least one reference value.

Preferably, the method comprises the control of the machining unit and/or of a doffing apparatus and/or of a residual material doffing apparatus and/or of a marker based on the result of the quality control.

Since the flexible material of the invention is conveyed on the conveyor, e.g., a printer or a laser marker of the marking unit may mark the material part, even without quality control.

A reworkable material part may include, e.g., a small hole, which was cut out by means of a laser and then, by the hot edges of the material, adhered to the hole cutout again.

### SHORT DESCRIPTION OF THE DRAWINGS

FIG. 1 shows a perspective depiction of a conventional cutting machine with manual fabric material partial doffing and quality control.

FIG. 2 shows a schematic depiction of a first embodiment of the cutting machine of the invention with inline quality control.

FIG. 3 shows a schematic depiction of a second embodiment of the cutting machine of the invention with inline quality control.

FIG. 4a, b show, in a schematic depiction, variants of a third embodiment of the inline quality control of the invention.

FIG. 5 shows a schematic depiction a retrofit solution of the inline quality control of the invention at existing OPW cutting machines.

FIG. 6 shows a cutout material part.

FIG. 7 shows another cutout material part with tolerance ranges;

FIG. 8 shows a method of the inline quality control of the invention.

### EMBODIMENTS OF THE DISCLOSURE

In the following, the invention is described by means of an airbag cutting machine. However, the invention is not limited to cutting and inspecting or marking, respectively, OPW fabric and can be transferred to many areas of application, in which flexible materials are cut by a cutting process. So, it is possible to cut single-layered or multi-layered sheets or foils from metal or plastic, coated or uncoated, by means of a laser cutting machine. These cut material parts may be, e.g., battery electrodes, sheet or foil parts, or seat covers.

In the following are, identical reference signs are used for identical and similarly acting elements, if not indicated otherwise. The depicted elements are not to be considered to be drawn to scale, rather, individual elements may be depicted excessively large for better understanding.

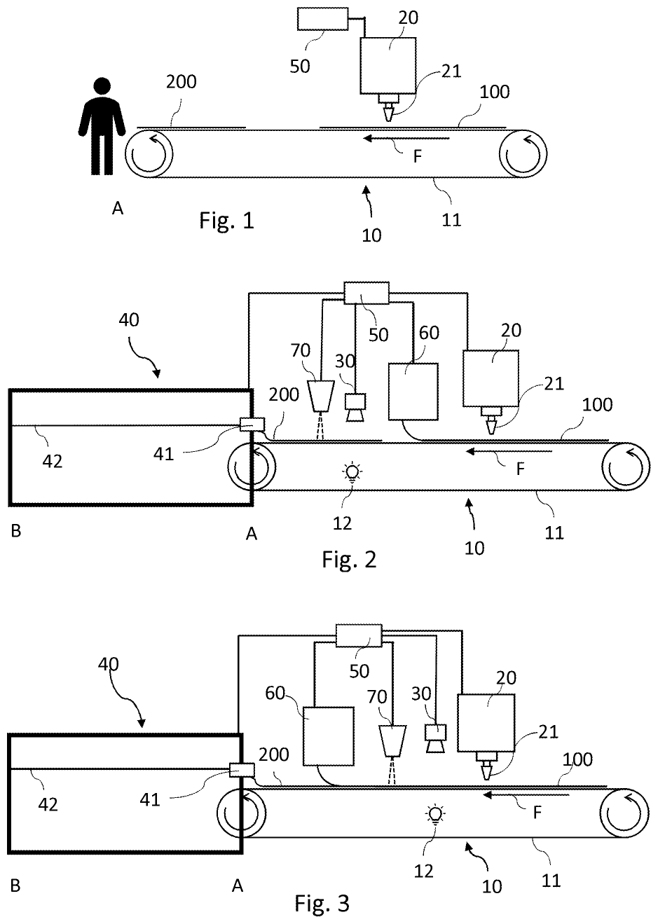

FIG. 1 shows a conventional cutting machine. After the cutting process of the fabric material band 100, the cut fabric material parts 200 are doffed from the conveyor 10 manually by employees. After the cutting process of the fabric material band 100, the clippings are separated from the fabric material parts 200 by the employees. Subsequently, the fabric material parts 200, which frequently comprise very many tabs, are put down on a table and undergo manual quality control by an employee.

An object of the present invention is to specify an inline quality control, which provides increased quality reliability, provides an increased degree of automation, and provides a reproducible result, to reduce the number of possible sources of defect and the effect of human tolerances.

Further, the inline quality control of the invention should be able to also be retrofitted to existing machines.

The conveying direction F is defined as the direction in which the fabric material band 100 or the fabric material parts 200 are moved on the conveyor 10. The conveying direction F is depicted by an arrow in FIGS. 2 to 4b. Formulations as above and below, over or under and horizontal and vertical, respectively, describe the posture of the components in an established system or how these components are arranged in the figures, respectively.

In order to overcome the abovementioned disadvantages, therefore, an inline quality control of the fabric material parts 200 is proposed as depicted in FIGS. 2 to 5, which is performed at the same conveyor 10, on which also the machining of the fabric material band 100 occurs or immediate cooperates with the conveyor 10 associated with the machining unit 20, so that the machined fabric material parts 200 must not at first be doffed and then laid out, aligned, and flattened again.

FIGS. 2 to 4b show different embodiments the automated cutting machine with inline quality control of the invention. The machines in FIGS. 2 to 4b differ, inter alia, in the arrangement or position of the residual material doffing apparatus 60 separating the clippings or the residual fabric from the fabric material parts 200. The residual material doffing apparatus 60 may, e.g., roll up and/or discharge upwards the residual material or residual fabric.

In FIG. 2, the residual material doffing apparatus 60 is arranged in the conveying direction after the machining unit 20, i.e., the residual material doffing apparatus 60 is arranged between the machining unit 20 and recognition unit or camera 30, respectively.

In FIG. 3, the residual material doffing apparatus 60 is arranged in the conveying direction before the doffing apparatus 40 but arranged after the recognition unit 30.

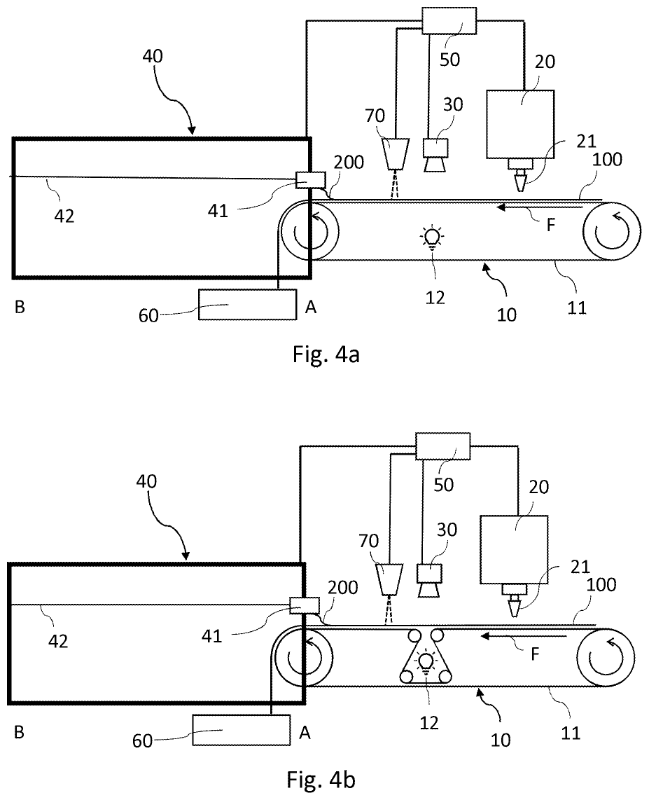

In FIGS. 4a and 4b, the clippings or the residual material is collected in a box at end of the conveyor 10 of the residual material doffing apparatus 60. The airbag cutting machine with the automated inline quality assurance of the invention comprises a conveyor 10, on which the fabric material band 100 is conveyed, a machining unit 20, preferably a laser cutting apparatus, with at least one movable laser cutting head 21 or one or more laser scanners cutting out the fabric material parts 200, which are then conveyed further on the conveyor 10 in the direction of the doffing apparatus 40, especially to the doffing position A. Between of the doffing position A and the machining unit 20, an inline quality control occurs, for example by means of a camera 30 or a line camera (not depicted) inspecting the shape, contour, size, warpage, and/or cutting sequence, and/or markings or holes of the cut fabric material parts 200 or of the whole fabric material band 100, respectively.

Here, for example, a comparison of cutting markings of the fabric material parts 200 with the target pattern or a reference is made, and it is verified, whether the cutting markings (cuts or cutting seam) lie within the tolerance of the target pattern specifications. Alternatively or additionally, the position and/or the number of holes or openings within the fabric material parts 200 may be inspected. This comparison may be made based on data having been used for driving the machining unit 20. The quality control provides the statement or the quality result, respectively, whether a cut fabric material part 200 meets the requirements or should be treated as scrap or as a part that can be post-processed.

The quality control may be done by means of a control unit 50 comparing the target specifications stored or supplied by the machining unit 20 with the actual data recorded by the recognition unit 30 taking into account the tolerance values, to identify a good fabric material part 200. The recognition unit 30 may be designed as a camera, in order to, by means of the photos or images taken with the camera 30, detect the dimensions of the fabric material parts 200 and/or cuttings or seams and compare them to the specifications. To do so, brightness and/or contrast differences between fabric material part 200 and pattern are detected, thereby enabling the exact recognition of the position and length of the cuts, seams, number and position of holes, weavings, and tabs in the photo of the recognition unit 30.

The recording area of the camera 30 may be selected in this course such that complete fabric material parts 200 may be recorded in order to perform a target-actual comparison, e.g., by comparing the target pattern with the actual pattern or by comparing the target cutting coordinates with the actual cutting coordinates, based on these recordings.

However, it is also possible, especially with larger fabric material parts 200, that a plurality of partial recordings of one fabric material part 200 is taken in sequence and these are subsequently composed to an overall recording of the fabric material part 200, to then be inspected. In this course, also the single recordings may already be inspected for deviations.

Further, it is also possible for the camera 30 to be realized in the form of one or more line cameras recording the whole width of the conveyor belt 11 and the fabric material part 200 resting on top after the cutting process. The width of a recording of the line camera in the conveying direction may be reduced to a pixel length or a few pixel lengths, respectively. The multiple recordings of the line camera are then composed to a line image to recognize whether a cut extends into areas of the fabric material part 200 that are weaved or welded or may not be cut in general.

The recording frequency of the camera 30 is adapted to the conveying speed of the conveyor 10 or synchronized to the conveying speed of the conveyor 10 to obtain a full recording of the fabric material parts 200 without any overlaps. Preferably, a target-actual comparison may be performed already with the current recording of the camera 30, especially of the line camera, before a fabric material part 200 is fully cut out and the single recordings of the fabric material part 200 are composed to an overall recording, to recognize defects of the fabric material part 200 as early as possible and thus to avoid producing a plurality of fabric material parts 200 with the same defect.

The control unit 50 is configured to recognize, in the recordings of the camera 30, the cutting edges 62 and weaved, welded, or sewn areas 63. The cutting area 64 could, for example, be clearly darker in the recording compared to the OPW fabric material part 200. Weaved, welded, or sewn/adhered areas 63 may have a different surface structure compared to not weaved, welded, or sewn areas, and thereby be identified by the control unit 50. However, it is also possible that these areas may be recognized by another reflection of the light of the control unit 50. With an illumination from a side opposite the camera 30 by means of additional illumination 12, cutting markings or cutting edges 62 and cutting areas 64 may be recognized by the control unit 50 in the recording as dark areas, and weaved, welded, or sewn areas 63 as bright areas.

If the control unit 50 recognizes a defect, a possible reaction to a defect may be throttling the speed of the conveyor 10. This reaction to a defect may be especially reasonable with incomplete cuts. If the control unit 50 recognizes the cause of defect, there is a possibility that the control unit 50 makes a correction of parameters in the machining unit 20. For example, the control unit 50 may be designed to reduce the cutting speed, correct parameters of the laser cutting machine, and/or readjust the position of the cutting apparatus in case of an offset of the cutting lines from the target position. Similarly, with an accumulation of badly or incompletely cut fabric material parts 200, it is possible to increase the power of the laser cutting heads to reach a complete cut.

FIG. 6 shows an exemplary cutting pattern of a fabric material part 200. In FIG. 6, the cut fabric material part 200 laying within of the residual fabric 61 of the fabric material web 100 may be recognized in the inner area. The cutting area 64 the or the cutting seam 62 is located in-between. The dimensions of the cut fabric material part 200 are compared to a target specification or a reference, respectively.

FIG. 7 shows another exemplary cutting pattern of a fabric material part 200. In FIG. 7, the target specification is depicted by a solid line. Permitted outer and inner tolerances are depicted as dashed lines, respectively. The depiction is only an example, and the dimensions of the permitted tolerances are selected exceptionally large for purposes of illustration and do not correspond to reality. Actually, the tolerances in manufacturing OPW fabric material parts for airbags are very small. The inner and/or outer tolerance specifications may be an independent pattern, arranged in relation to the alignment of the position of the cutting pattern in or around it. This provides the advantage that different tolerances along the cutting pattern of the fabric material part 200 may be selected. However, it is also but possible that the tolerance is defined as a consistent interval from the cutting seam or as a ratio to cutting pattern. Further, it is possible that, for example, the inner tolerance may be selected smaller than the outer tolerance (as exemplarily depicted in FIG. 7).

A permanent comparison of the cutting lines with the target specifications allows to already recognize and correct values slowly drifting away before an actual defect occurs. The control unit 50 may be formed to store the corrections and adaptively correct the machining unit 20.

Thereby, a reduction of the scrap amount is possible. The corrections of the control unit 50 may be monitored as well and, in case of an overshoot of predetermined limits, a defect may be output, or this may be an indication of wear of the machine or specific components of the machine, respectively.

Further, there is a possibility that, when the control unit 50 is not able to attribute the defect, the machine is stopped and/or a signal may be output (e.g., acoustically or optically), to indicate the defect to a machine operator.

Further, the control unit 50 may also be configured to recognize fabric material parts 200 already marked defective before the machining of the machining unit 20. For example, defectively weaved fabric material band 100 may be marked defective immediately after the weaving at the corresponding places, e.g., by a not depicted marking unit 70 arranged in the conveying direction before the machining unit 20. Thereby, for example, only the defective areas of a fabric material band 100 may be reliably rejected and, thus, the scrap may be reduced. Further, this may avoid, in the quality control after the machining unit 20, erroneously identifying fabric material parts 200 having defects of previous machining stations as “good” parts.

However, there is also a possibility that the control unit 50 obtains information pertaining to the machining quality of the previous station digitally or as a file, respectively. Fabric material parts 200 or areas of the fabric band 100, respectively, already recognized as defective before the machining unit 20 may then not be erroneously classified as a “good” part anymore.

With the quality result thus generated for each individual fabric material part 200, the doffing apparatus 40 may be driven. Thus, the individual doffing modules 41 of the doffing apparatus 40 according to FIGS. 2 to 4 may be selectively driven, to only doff and transport to the storage position B the fabric material parts 200 recognized as “good”. If only one doffing module 41 exists at the doffing apparatus 40, it may be controlled such that only the “good” parts are doffed and the parts characterized as scrap are not doffed and either discharged through the residual material doffing apparatus 60 or led into a collection box at end of the conveyor. Thus, the scrap parts are not picked up and transported by the conveyor 10 and/or the doffing apparatus 40 and/or the residual material doffing apparatus 60 to a not depicted scrap container.

The doffing apparatus 40 may comprise one or more doffing modules 41 with one or more suction grippers and/or clamping grippers (not depicted). With the suction gripper, the fabric material parts 200 may be raised, lifted, or held off the conveyor belt 11, and optionally subsequently fixed with clamping gripper. The one or more doffing modules 41 are preferably movable in the conveying direction along linear supports 42 to doff the fabric material parts 200 off the conveyor belt 11 at the doffing position A and transport them to the storage position B. Further preferably, the doffing modules 41 may be movable horizontally transversely to the conveying direction, so that a doffing module 41 may doff fabric material parts 200 arranged, offset from each other in the conveying direction, on the conveyor belt 11. It is also possible to only provide one doffing module.

In order to ensure sufficient illumination of the fabric band or of the cutting edges or of the cutting areas, respectively, an illumination unit 12 may be provided between the conveyor belt 11 and the fabric band 100. This may be realized as in FIG. 4b in that the conveyor belt 11 extends below the illumination unit. However, it is also possible that the conveyor belt 11 is interrupted in the recording area of the recognition unit 30 and a flat light box, through which the fabric material band 100 is led, is arranged such that it may be illuminated from below.

The camera 30 may further comprise an illumination (not depicted) to also illuminate the recording area from and/or or from the side. There is also a possibility that the illumination is arranged separately from the camera 30 in the proximity of the recording area. Besides the conventional illumination of the recording area, an additional illumination 12 may be arranged on a side of the conveyor belt 11 opposite the camera 30. In a case where the camera 30 is arranged on of a top surface of the conveyor belt 11, the additional illumination 12 is located on a bottom side of the conveyor belt 11 or the camera 30 is located below the conveyor belt 11 and the additional illumination 12 above the conveyor belt 11.

Preferably, the conveyor belt 11 may be formed of a transparent material or have openings, so that light may be irradiated to the fabric material parts 200 from below and the fabric material parts 200 or the cuts etc., respectively possible, especially in connection with a line camera, to guide the conveyor belt 11 around the illumination, as for example depicted in FIG. 4b. It is also possible to place an illumination unit 12 between the conveyor belt 11 and the material web 100 and to pull the flexible material 100 over the illumination unit 12. Thereby, the illumination unit 12 is formed as a flat light box.

By a strong illumination from an opposite side of the camera 30, welding seams 63, markings 66, holes 67, or weaved places 63 of the fabric material parts 200 may be made better visible for the camera 30 such that defects, e.g. in welding seams 63 or weaved places 63, may be detected more easily and more reliably. Further there is a possibility to record each cutout of a fabric material part 200 multiple time with the different illumination sources 12. For example, when the camera 30 is arranged above the conveyor belt 11, a first recording may be made only with the illumination from above, a second recording only with the additional illumination 12 from below, and a third recording with both illumination sources 12. The recordings with the respective same illumination source may be then respectively composed again to an overall recording (in this case 3 overall recordings). By the different illuminations, defects not visible with conventional illumination may be detected even better. In addition, by multiple recordings, redundancy is enabled, which ensures additional security.

Also, different wavelengths, different spectra, or a UV irradiation may be used to better represent the contrasts. That is, the wavelength of the illumination 12 or also of the recognition unit 30, respectively, may be adapted to a material.

The scrap parts may be organized in at least two categories. Fabric material parts 200, which, for example, are cut out incompletely or whose cut relating to the outline of the target specification lies outside the target cutting edge may be reworked. Scrap parts, whose holes 67 do not lie at the target positions and/or whose cut lies on an inner side of the specification and/or whose cut lies in an area that may not be cut in general, may not be reworked, are declared scrap, and rejected.

Further there is a possibility to indicate the scrap parts by means of a marker 70, to securely avoid erroneous further processing of the scrap parts. A marking of the scrap parts may occur by means of laser, color, or any other manner suited to clearly mark the scrap part as defective or actively cut it up. Preferably, the marker 70 is arranged between the quality control or the camera 30, respectively, and the doffing apparatus 40.

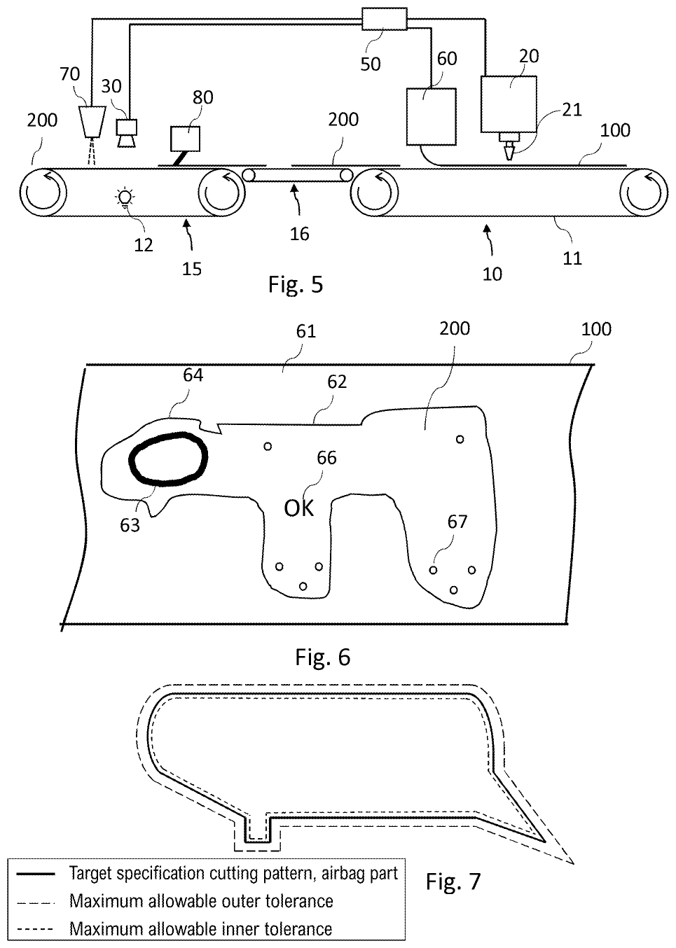

FIG. 5 shows a machine without quality control, at which an inline quality control of the invention was retrofitted. Elements with identical reference signs are not described again, the previous description also applies to the components in this embodiment.

In order to allow an integration of the inline quality control in the existing system as easily and cost-effectively as possible, as many components as possible should be allowed to be kept. The machine depicted in FIG. 5 was integrated in this case as an example in the machine from FIG. 1. The conveyor 11 was connected by a connection member 16 to a second conveyor 15, on which so far, the manual doffing and, if applicable, a quality control occurred. The connection member 16 may be realized in the form of sliding sheets, roll bearings, as a conveyor belt, or in any other shape that allows a transport of the fabric material part 200 from the conveyor belt 11 onto the second conveyor 15, so that the fabric material part 200 then must not be laid out, aligned, and flattened again. However, it is also possible to arrange the components above an existing conveyor 10 such that the camera 30 for quality control may be arranged after the machining machine 20 without a second conveyor 15.

The automated inline quality control then occurs on the second conveyor 15 or the portion of the conveyor 10 after the machining machine 20.

The camera 30 and the marker 70 as well as the one or more illuminations 12 are arranged above or in, respectively, the second conveyor 15. After the second conveyor 15, the fabric material parts 200 may be doffed either by an employee or by a doffing apparatus 40 (not depicted).

That is, the doffing apparatus 40 is optional and may also be omitted in respective use cases. Similarly, the residual material doffing apparatus 60 and the marking unit 70 may be omitted.

The automated inline quality control may also easily be switched back to the manual quality control. This may be reasonable when the control unit 50, with very small quantities, has no target data. Therefore, the connection member 16 is easily removed and replaced by employees. The flattening apparatus 80, in this case, may also be easily put back into operation.

The camera 30 may lie within the machining area of the laser cutting machine 20, to thus mark the parts, immediately when recognizing a defect, by cutting them up and/or the cutting process may be terminated for this part.

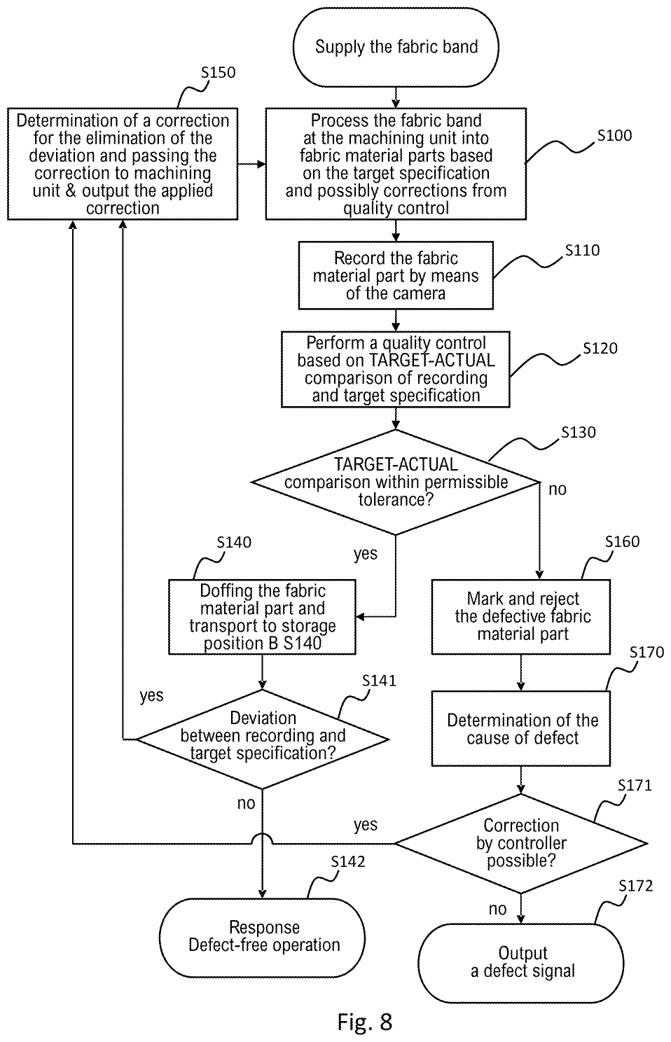

In FIG. 8, a method of the inline quality control of the invention is depicted. The flow diagram depicted in FIG. 8 for a method for inline quality control shows a method with very extensive functions. In its most simple embodiment, not all these steps are required. This will be explained in detail in the following.

In its most simple embodiment, the method of the inline quality control of the invention comprises the steps of processing the fabric material band 100 at the machining unit 20 to fabric material parts 200 based on a target specification S100; recording the fabric material part 200 by means of the camera S110; performing a quality control based on a TARGET-ACTUAL comparison of the recording of the fabric material part 200 with the target specification of the fabric material part S120; and evaluating whether the fabric material part 200 has been manufactured within the permitted tolerance S130.

If all cuttings, seams, weaved places 63, holes 67, markings 66, and cutting edges 62 of the fabric material part 200 are present and if their positions are located at the correct place or within the permitted tolerance, respectively, the fabric material part 200 is recognized as good and doffed from the doffing apparatus 40 at the position A and transported to the storage position B S140.

If not all cuttings, seams, weaved places, holes, and cutting edges of the fabric material part 200 exist or if one of them is not located at the correct place or outside the permitted tolerance, respectively, the fabric material part 200 is recognized as scrap S130 and may be correspondingly marked by a marker 70 S160 and supplied from the doffing apparatus 40 or the residual fabric extraction apparatus 60 or otherwise to a separate scrap container.

The TARGET data for matching the TARGET specification to the recording of the fabric material part 200 may be based on the TARGET data underlying the machining station 20 for machining the fabric band 100.

Thereby, the step of receiving S110 the fabric material part 200 by means of the camera 30 may occur in different ways.

In a special embodiment, it is possible that already recognized material defects, as for example flaws in weaving, may be supplied to both, the machining unit 20 as well as the quality control, as an input magnitude. Thereby, erroneously recognizing fabric material parts 200 lying in the area of a known defect as good and processing them is prevented. Here, it is also possible to already suspend the cutting process when a position of a fabric material part 200 lies in an area of the fabric web 100 where a known defect lies.

1. A cutting machine, comprising:
a conveyor (10) for conveying flexible material (100);
a machining unit (20) for cutting said flexible material (100) into material parts (200);
a recognition unit (30) for detecting said flexible material (100) and/or at least one cut material part (200), said recognition unit (30) is arranged in the conveying direction after said machining unit (20),
a control unit (50) configured to generate a quality result based on information of said recognition unit (30) and/or on marking information.

2. The cutting machine of claim 1, further comprising:
a marking unit (70) for marking said flexible material (100) and/or said at least one cut material part (200) based on said quality result, said marking unit (70) being arranged in the conveying direction before and/or after said machining unit (20).

3. A cutting machine, comprising:
a conveyor (10) for conveying flexible material (100);
a machining unit (20) for cutting said flexible material (100) into material parts (200);
a marking unit (70) for marking said flexible material (100) and/or said at least one cut material part (200) based on information of said cutting machine and/or of said flexible material (100), said marking unit (70) being arranged in the conveying direction before and/or after said machining unit (20).

4. The cutting machine of claim 3, comprising:
a recognition unit (30) for detecting said flexible material (100) and/or at least one cut material part (200), said recognition unit (30) arranged in the conveying direction after said machining unit (20); and
a control unit (50), configured, based on information of said recognition unit (30) and/or on marking information, to generate a quality result and to control said cutting machine.

5. The cutting machine of claim 1, wherein said flexible material (100) is selected from the group comprising: a flexible fabric, a single-layered or multi-layered plastic sheet or a single-layered or multi-layered metal sheet, a textile, a technical textile, and/or an at least partly single-layered, double-layered, and/or multi-layered fabric.

6. The cutting machine of claim 1, further comprising a doffing apparatus (40) for doffing said at least one cut material part (200) of said conveyor (10), said doffing apparatus (40) being arranged after said recognition unit (30) and/or after said marking unit (70).

7. The cutting machine of claim 6, further comprising a residual material doffing apparatus (60) for doffing a residual material, said residual material doffing apparatus (60) being arranged in the conveying direction before or after said recognition unit (30) and/or in the conveying direction before or after said marking unit (70) or said residual material doffing apparatus (60) being arranged in the conveying direction at the same position as said doffing apparatus (40) or in the conveying direction after said doffing apparatus (40).

8. The cutting machine of claim 7, further comprising a control unit (50) configured to control said machining unit (20) and/or said doffing apparatus (40) and/or said residual material doffing apparatus (60) and/or said marking unit (70) based on information on said recognition unit (30) and/or on marking information.

9. The cutting machine of claim 1, wherein said recognition unit (30) comprising a camera and/or a transmitter and a receiver, one or more sensors, and/or an illumination unit (12).

10. The cutting machine of claim 9, wherein said illumination unit (12) outputs light with a wavelength adapted to the material or a material composition and/or wherein said flexible material (100) is arranged between said transmitter and said receiver, wherein said transmitter outputs ultrasound or a radiation with predetermined wavelength which is received by said receiver to obtain information on said material composition of said flexible material (100).

11. The cutting machine of claim 9, wherein said illumination apparatus (12) being arranged on a side of said recognition unit (30) opposite to said flexible material (200) and/or facing said flexible material (200) or said illumination apparatus (12) arranged between said conveyor (10) and said flexible material (100).

12. The cutting machine of claim 1, wherein said quality result is based on an inspection on at least one of the following criterions:
position and number of the seams,
position and number of cutouts/holes, and/or on the
quality of weaved places and/or welding seams and/or adhesive areas,
position of said weaved places, adhesive areas, and/or welding seams,
position of markings at said flexible material (100),
whether the outer contour lies within a predetermined tolerance range,
position of said pattern to said weaved positions, and/or
material warpage.

13. The cutting machine of claim 1, wherein said control unit (50) is configured to inspect said at least one cutout material part (200) for warpage, and/or whether the length and/or the width of said at least one cutout material part (200) corresponds to the target or reference specifications, and/or whether tabs, protrusions, or cutouts at said at least one cutout material part (200) are arranged in the respective correct position, and/or whether said outer contours lie in previously designated areas.

14. The cutting machine of claim 1, wherein said recognition unit (30) recognizes a marking (66) of material defects or material defects of said flexible material (100) are included in a file which is processed by said control unit (50) of said cutting machine.

15. The cutting machine of claim 1, wherein said flexible material (100) is a fabric band for airbag production, especially a OPW fabric band, and said machining unit (20) is a laser cutting apparatus for cutting out of fabric material parts (200) for airbag production and said control unit (50) is configured to, at a positive quality result is configured, to approve the corresponding cut fabric material part (200) for doffing and, at a negative quality result, categorize a defective airbag part as a scrap part or as a reworkable airbag part.

16. The cutting machine of claim 15, wherein said control unit (50) is configured to control the doffing apparatus (40) such that said scrap parts and said reworkable OPW fabric material parts (200) are stored separately from each other, and/or wherein said control unit (50) is configured to identify a defect and/or a cause of defect and/or to correct these, and/or output hints for defects and/or wear to said cutting machine based on the information of said recognition unit (30).

17. The cutting machine of claim 15, wherein said control unit (50) is configured to display an approved airbag part and/or, in case of a negative quality result, to display a defective airbag part as a scrap part or as a reworkable airbag part, by means of an optical output unit and/or a marking and/or projection onto said airbag part.

18. The cutting machine of claim 1, wherein said control unit (50) is configured to perform said quality control during a continuous and/or discontinuous and/or stopped operation of said cutting machine.

19. A method for automated inline quality control of at least one material part (200) cut out from a flexible material (100), comprising the following steps:
supplying a flexible material (100) on a conveyor (10),
cutting (S100) said flexible material (100) by means of a machining unit (20) into one or more material parts (200);
detecting (S110) at least a part of said flexible material (100) and/or of said cutout material part (200) by means of a recognition unit (30); and
performing (S120-S130) a quality control based on information of said recognition unit (30) and at least one reference value.
